(19) United States
(12) Patent Application Publication
(10) Pub. No.: US 2026/0256050 A1
(43) Pub. Date: Sep. 3, 2026

(54) INTELLIGENT SELF-SEQUENCING RICE SEEDLING THROWING MACHINE

(71) Applicant: HUNAN ACADEMY OF AGRICULTURAL SCIENCES, Changsha (CN)

(72) Inventors: Jingbo XU, Changsha (CN); Ming LI, Changsha (CN); Gang YIN, Changsha (CN); Liang ZHANG, Changsha (CN); Huanglin DONG, Changsha (CN); Wenbang TANG, Changsha (CN); Zhiwei WANG, Changsha (CN); Jinqi HUANG, Changsha (CN); Huru WEI, Changsha (CN); Zhongwei WEI, Changsha (CN); Yaliang WANG, Changsha (CN); Hui LI, Changsha (CN); Jianghe LUO, Changsha (CN); Mingjian ZHENG, Changsha (CN)

(73) Assignee: HUNAN ACADEMY OF AGRICULTURAL SCIENCES, Changsha (CN)

(21) Appl. No.: 19/654,491

(22) Filed: Apr. 22, 2026

Related U.S. Application Data
(63) Continuation of application No. PCT/CN2025/099234, filed on Jun. 5, 2025.

(30) Foreign Application Priority Data
Sep. 4, 2024 (CN) 202411235635.X

(51) Int. Cl. A01C 11/00; A01C 11/02

(52) U.S. Cl. CPC A01C 11/003; A01C 11/006; A01C 11/02

(57) ABSTRACT

An intelligent self-sequencing rice seedling throwing machine is provided. A seedling box, a first belt seedling conveyor, a second belt seedling conveyor, and a blower are mounted on a chassis. A seedling picker is installed inside the seedling box and is located at the seedling outlet of the seedling box. The first belt seedling conveyor is located below the seedling outlet of the seedling box. The second belt seedling conveyor is located below the first belt seedling conveyor. An air outlet of the blower is located below the point where seedlings fall from the end of the second belt seedling conveyor. A first seedling combing device is installed above the first belt seedling conveyor. Seedlings pass through the gap between the first belt seedling conveyor and the first seedling combing device and fall onto the second belt seedling conveyor.

### CROSS REFERENCE TO THE RELATED APPLICATIONS

This application is the continuation application of International Application No. PCT/CN2025/099234, filed on June 5, 2025, which is based upon and claims priority to Chinese Patent Application No. 202411235635.X, filed on September 4, 2024, the entire contents of which are incorporated herein by reference.

### TECHNICAL FIELD

The present invention relates to the field of agricultural machinery, and in particular, to an intelligent self-sequencing rice seedling throwing machine.

### BACKGROUND

The promotion and application of rice seedling throwing technology has greatly reduced labor intensity and is an innovation and reform in rice cultivation technology. Patent publication number CN118160472A discloses "A Pneumatic Seedling Throwing Machine and Its Throwing Method", which includes a seedling supply device, a differential speed transmission device, and a throwing device, using the differential speed transmission device to control throwing row spacing. Since the traveling speed of the throwing machine affects the throwing row spacing, the control stability of the throwing row spacing is poor. Furthermore, this patent technology cannot control throwing density, and the stability of the throwing posture is poor. To solve the above problems, there is an urgent need to develop an intelligent self-sequencing rice seedling throwing machine capable of ensuring throwing posture stability and uniformity.

### SUMMARY

In view of the above, the present invention proposes an intelligent self-sequencing rice seedling throwing machine, which can ensure throwing posture stability and uniformity, achieve intelligent and orderly seedling throwing, and improve throwing efficiency.

In one aspect, the present invention provides an intelligent self-sequencing rice seedling throwing machine. A seedling box, a first belt seedling conveyor, a second belt seedling conveyor, and a blower are mounted on a chassis. A seedling picker is installed inside the seedling box and is located at a seedling outlet of the seedling box. The first belt seedling conveyor is located below the seedling outlet of the seedling box. The second belt seedling conveyor is located below the first belt seedling conveyor. An air outlet of the blower is located below a point where seedlings fall from an end of the first belt seedling conveyor. A first seedling combing device is installed above the first belt seedling conveyor. A rotation direction of the first seedling combing device is opposite to a rotation direction of the first belt seedling conveyor, and their rotation speeds are the same. A rotation speed of the second belt seedling conveyor is the same as the rotation speed of the first belt seedling conveyor. Seedlings pass through a gap between the first belt seedling conveyor and the first seedling combing device and fall onto the second belt seedling conveyor.

In a further technical solution, a second seedling combing device is installed on the second belt seedling conveyor, the second seedling combing device being located below a point where seedlings fall from an end of the first belt seedling conveyor; a rotation direction of the second seedling combing device is the same as a rotation direction of the second belt seedling conveyor; a rotation speed of the second seedling combing device is less than the rotation speed of the second belt seedling conveyor.

In a further technical solution, the first belt seedling conveyor is installed at an incline, the second belt seedling conveyor is installed horizontally; a front end of the first belt seedling conveyor is lower than a rear end thereof; an inclination angle R1 of the first belt seedling conveyor is 15-45 degrees; a distance H1 from the end of the first belt seedling conveyor to the second belt seedling conveyor is 50 mm-150 mm.

In a further technical solution, the rotation speed of the first belt seedling conveyor is 5-25 r/min; the rotation speed of the second belt seedling conveyor is 5-25 r/min; the rotation speed of the first seedling combing device is 5-25 r/min; the rotation speed of the second seedling combing device is 2-12 r/min; an air speed at the air outlet of the blower is 20-45 m/s; an inclination angle R2 of the air outlet of the blower is 20-45 degrees.

In a further technical solution, the first seedling combing device comprises a first comb shaft and at least two raking rods; the at least two raking rods are uniformly installed in a circumferential direction of the first comb shaft, each raking rod extending transversely along an axial direction of the first comb shaft.

In a further technical solution, the second seedling combing device comprises a second comb shaft and protrusions; the protrusions are uniformly installed on a circumferential surface of the second comb shaft.

In a further technical solution, a tray extending upward at an incline is installed on the air outlet of the blower; seedlings leaving the second belt seedling conveyor fall into the tray; under the action of air flow from the air outlet of the blower, the seedlings are thrown upward.

In a further technical solution, it comprises a first motor, a second motor, a third motor; the first motor drives the first belt seedling conveyor and the first seedling combing device to rotate; the second motor drives the second belt seedling conveyor and the second seedling combing device to rotate; the third motor drives the seedling picker to rotate.

In a further technical solution, it comprises a controller, a first sensor, a second sensor, a third sensor, a fourth sensor, a fifth sensor; the first sensor detects a rotation speed of the first motor; the second sensor detects a rotation speed of the second motor; the third sensor detects a rotation speed of the seedling picker; the fourth sensor detects an air speed at the air outlet of the blower; the fifth sensor detects a traveling speed of the chassis; the controller acquires signals from the first sensor, the second sensor, the third sensor, the fourth sensor, and the fifth sensor; controls throwing height and distance based on the rotation speed of the second motor and the air speed at the air outlet of the blower; controls throwing row spacing based on the traveling speed of the chassis; and controls throwing density based on the rotation speed of the first motor, the rotation speed of the second motor, and the rotation speed of the third motor.

Beneficial effects of the intelligent self-sequencing rice seedling throwing machine of the present invention relative to the prior art are as follows:

Under the action of the seedling picker, seedlings enter the first belt seedling conveyor from the seedling box. Since the rotation direction of the first seedling combing device is opposite to that of the first belt seedling conveyor, and their rotation speeds are the same, the seedlings are blocked by the first seedling combing device and pass through the gap between the first belt seedling conveyor and the first seedling combing device to fall onto the second belt seedling conveyor, achieving primary dispersion of the seedlings. After primary dispersion, the uniformly distributed seedlings are conveyed on the first belt seedling conveyor. Since the first belt seedling conveyor is installed at an incline, the seedlings are thrown upward when leaving the first belt seedling conveyor. Undispersed clumps of seedlings fall onto the second seedling combing device. Since the rotation speed of the second seedling combing device is less than that of the second belt seedling conveyor, and their rotation directions are the same, part of the clumps are further dispersed under the action of the second seedling combing device. Because the weight of the seedling roots is greater than that of the stems, and under the action of rotating airflow from the second seedling combing device, the seedlings land on the second belt seedling conveyor with stems trailing and roots leading, achieving primary posture adjustment and secondary dispersion of the seedlings. After primary posture adjustment and secondary dispersion, the seedlings are intelligently and orderly uniformly distributed and conveyed on the second belt seedling conveyor. Since the air outlet of the blower faces upward, the seedlings leaving the second belt seedling conveyor fall into the tray and are thrown upward. Because the weight of the seedling roots is greater than that of the stems, and the air flow from the blower's air outlet is upward, the seedlings follow a parabolic trajectory, landing in the field with stems up and roots down, completing the seedling throwing operation. Therefore, during the throwing process, the seedlings undergo primary dispersion, secondary dispersion, primary posture adjustment, and secondary posture adjustment, which can ensure throwing posture stability and uniformity, achieve intelligent and orderly seedling throwing, and improve throwing efficiency.

### BRIEF DESCRIPTION OF THE DRAWINGS

The accompanying drawings, which constitute a part of the present invention, are provided to further understand the present invention. Schematic embodiments of the present invention and their descriptions are used to explain the present invention and do not constitute an improper limitation thereof. In the drawings:

FIG. 1 is a perspective structural schematic diagram of the intelligent self-sequencing rice seedling throwing machine of the present invention;

FIG. 2 is a structural schematic diagram of the first belt seedling conveyor, the first seedling combing device, the second seedling combing device, and the second belt seedling conveyor of FIG. 1;

FIG. 3 is a side view of FIG. 1;

FIG. 4 is a front view of FIG. 1;

FIG. 5 is a schematic diagram of the control system of the intelligent self-sequencing rice seedling throwing machine of the present invention.

### DETAILED DESCRIPTION OF THE EMBODIMENTS

It should be noted that the embodiments of the present invention and the features of the embodiments may be combined with each other in the absence of conflict. The present invention will be described in detail below with reference to the accompanying drawings and embodiments.

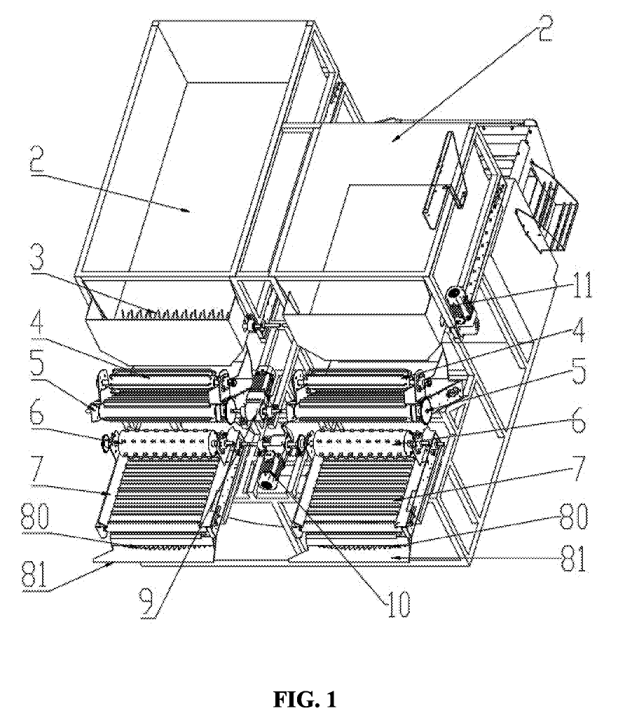

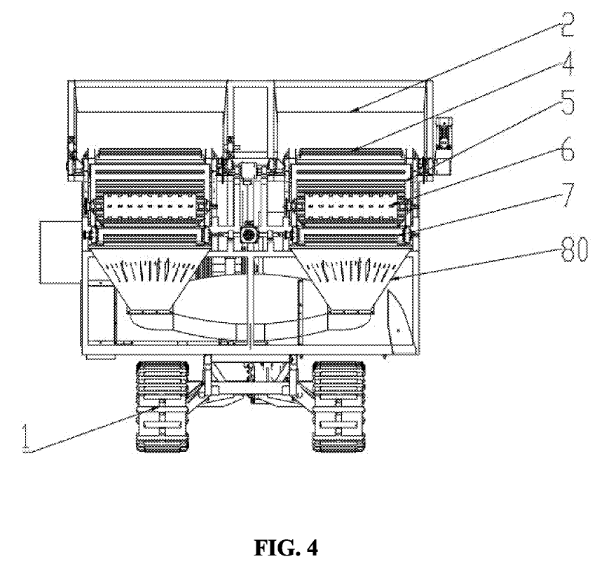

As shown in FIGS. 1 to 5, the present invention prefers an intelligent self-sequencing rice seedling throwing machine. Two seedling boxes 2, two first seedling combing devices 4, two first belt seedling conveyors 5, two second seedling combing devices 6, two second belt seedling conveyors 7, and one blower 8 are mounted on a chassis 1. A seedling picker 3 is installed inside each seedling box 2, located at the seedling outlet of the seedling box 2. The rotation of the seedling picker 3 causes seedlings within the seedling box 2 to be discharged. A first motor 9 drives the two first belt seedling conveyors 5 and the two first seedling combing devices 4 to rotate. A second motor 10 drives the two second belt seedling conveyors 7 and the two second seedling combing devices 6 to rotate. A third motor 11 drives the seedling pickers 3 to rotate. The first belt seedling conveyor 5 and the first seedling combing device 4 are driven by a chain, and the second belt seedling conveyor 7 and the second seedling combing device 6 are driven by a chain.

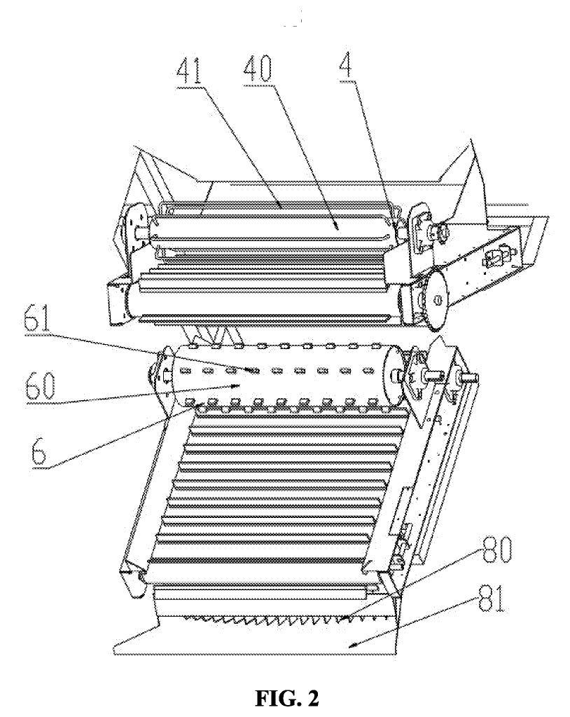

As shown in FIGS. 2-4, the first belt seedling conveyor 5 is located below the seedling outlet of the seedling box 2. The second belt seedling conveyor 7 is located below the first belt seedling conveyor 5. The air outlet 80 of the blower 8 is located below the point where seedlings fall from the end of the second belt seedling conveyor 7. The first seedling combing device 4 is installed above the first belt seedling conveyor 5. The rotation direction of the first seedling combing device 4 is opposite to that of the first belt seedling conveyor 5, and their rotation speeds are the same. The second seedling combing device 6 is installed on the second belt seedling conveyor 7, located below the point where seedlings fall from the end of the first belt seedling conveyor 5. The rotation direction of the second seedling combing device 6 is the same as that of the second belt seedling conveyor 7, and the rotation speed of the second seedling combing device 6 is less than that of the second belt seedling conveyor 7. The rotation speed of the first belt seedling conveyor 5 is the same as that of the second belt seedling conveyor 7.

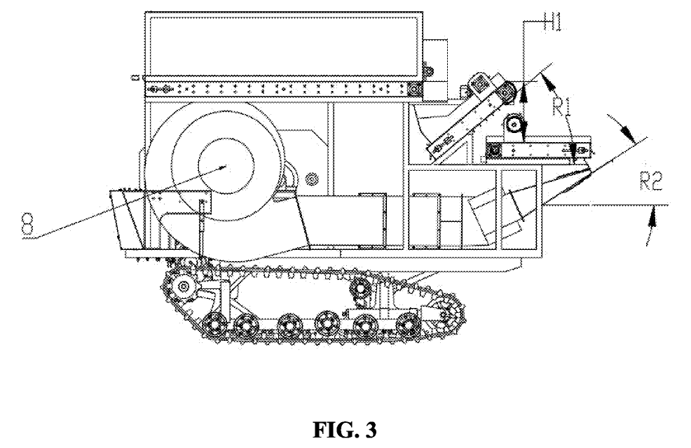

As shown in FIG. 3, the first belt seedling conveyor 5 is installed at an incline, and the second belt seedling conveyor 7 is installed horizontally. The front end of the first belt seedling conveyor 5 is lower than its rear end. The inclination angle R1 of the first belt seedling conveyor 5 is 35 degrees. The distance H1 from the end of the first belt seedling conveyor 5 to the second belt seedling conveyor 7 is 150 mm. The rotation speed of the first belt seedling conveyor 5 is 25 r/min, the rotation speed of the second belt seedling conveyor 7 is 25 r/min, the rotation speed of the first seedling combing device 4 is 25 r/min, the rotation speed of the second seedling combing device 6 is 12 r/min, the air speed at the air outlet 80 of the blower is 45 m/s, and the inclination angle R2 of the air outlet 80 of the blower is 45 degrees. Experiments have proven that the above technical parameters can ensure throwing posture stability and uniformity, achieve intelligent and orderly seedling throwing, and improve throwing efficiency.

As shown in FIG. 2, the first seedling combing device 4 comprises a first comb shaft 40 and at least two raking rods 41. The at least two raking rods 41 are uniformly installed in the circumferential direction of the first comb shaft 40, each raking rod 41 extending transversely along the axial direction of the first comb shaft 40. The second seedling combing device 6 comprises a second comb shaft 60 and protrusions 61. The protrusions 61 are uniformly installed on the circumferential surface of the second comb shaft 60. A tray 81 extending upward at an incline is installed on the air outlet 80 of the blower. Seedlings leaving the second belt seedling conveyor 7 fall into the tray 81 and are thrown upward under the action of air flow from the air outlet 80 of the blower.

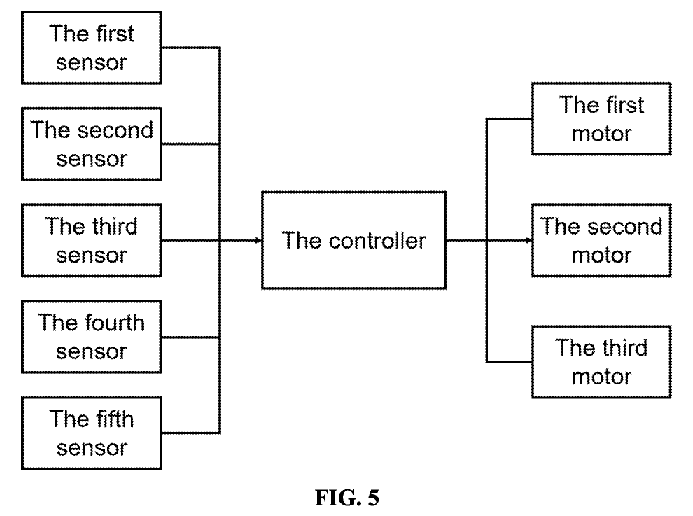

As shown in FIG. 5, it comprises a controller, a first sensor, a second sensor, a third sensor, a fourth sensor, a fifth sensor. The first sensor detects the rotation speed of the first motor 9. The second sensor detects the rotation speed of the second motor 10. The third sensor detects the rotation speed of the seedling picker 3. The fourth sensor detects the air speed at the air outlet 80 of the blower. The fifth sensor detects the traveling speed of the chassis 1. The controller acquires signals from the first sensor, the second sensor, the third sensor, the fourth sensor, and the fifth sensor; controls throwing height and distance based on the rotation speed of the second motor 10 and the air speed at the air outlet 80 of the blower; controls throwing row spacing based on the traveling speed of the chassis 1; and controls throwing density based on the rotation speed of the first motor 9, the rotation speed of the second motor 10, and the rotation speed of the third motor 11.

Under the action of the seedling picker 3, seedlings enter the first belt seedling conveyor 5 from the seedling box 2. Since the rotation direction of the first seedling combing device 4 is opposite to that of the first belt seedling conveyor 5, and the rotation speed of the first seedling combing device 4 (25 r/min) is the same as that of the first belt seedling conveyor 5, the seedlings are blocked by the first seedling combing device 4 and pass through the gap between the first belt seedling conveyor 5 and the first seedling combing device 4 to fall onto the second belt seedling conveyor 7, achieving primary dispersion of the seedlings. After primary dispersion, the uniformly distributed seedlings are conveyed on the first belt seedling conveyor 5. Since the first belt seedling conveyor 5 is installed at an incline with an inclination angle R1 of 35 degrees, the seedlings are thrown upward when leaving the first belt seedling conveyor 5. Undispersed clumps of seedlings fall onto the second seedling combing device 6 with a drop distance H1 of 150 mm. Since the rotation speed of the second seedling combing device 6 (12 r/min) is less than that of the second belt seedling conveyor 7, and their rotation directions are the same, part of the clumps are further dispersed under the action of the second seedling combing device 6. Because the weight of the seedling roots is greater than that of the stems, and under the action of rotating airflow from the second seedling combing device 6, the seedlings land on the second belt seedling conveyor 7 with stems trailing and roots leading, achieving primary posture adjustment and secondary dispersion of the seedlings. After primary posture adjustment and secondary dispersion, the seedlings are regularly and uniformly distributed and conveyed on the second belt seedling conveyor 7. Since the air outlet 80 of the blower faces upward, the seedlings leaving the second belt seedling conveyor 7 fall into the tray 81 and are thrown upward. Because the weight of the seedling roots is greater than that of the stems, and the air flow from the air outlet 80 of the blower is upward, with an air speed of 45 m/s and an inclination angle R2 of 45 degrees, the seedlings follow a parabolic trajectory, landing in the field with stems up and roots down, completing the seedling throwing operation. Therefore, during the throwing process, the seedlings undergo primary dispersion, secondary dispersion, primary posture adjustment, and secondary posture adjustment, which can ensure throwing posture stability and uniformity, achieve intelligent and orderly seedling throwing, and improve throwing efficiency.

Techniques not described above are common knowledge to those skilled in the art. The above descriptions are only preferred embodiments of the present invention and are not intended to limit the present invention. Any modifications, equivalent replacements, improvements, etc., made within the spirit and principles of the present invention shall be included within the protection scope of the present invention.

1. An intelligent self-sequencing rice seedling throwing machine, comprising:
a chassis on which a seedling box, a first belt seedling conveyor, a second belt seedling conveyor, and a blower are mounted; and
a seedling picker installed inside the seedling box, the seedling picker being located at a seedling outlet of the seedling box; the first belt seedling conveyor being located below the seedling outlet of the seedling box; the second belt seedling conveyor being located below the first belt seedling conveyor; an air outlet of the blower being located below a point where seedlings fall from an end of the second belt seedling conveyor;
wherein a first seedling combing device is installed above the first belt seedling conveyor; a rotation direction of the first seedling combing device is opposite to a rotation direction of the first belt seedling conveyor; a rotation speed of the first seedling combing device is same as a rotation speed of the first belt seedling conveyor; a rotation speed of the second belt seedling conveyor is same as the rotation speed of the first belt seedling conveyor; and seedlings pass through a gap between the first belt seedling conveyor and the first seedling combing device and fall onto the second belt seedling conveyor;
a second seedling combing device is installed on the second belt seedling conveyor; the second seedling combing device is located below a point where seedlings fall from an end of the first belt seedling conveyor; a rotation direction of the second seedling combing device is same as a rotation direction of the second belt seedling conveyor; and a rotation speed of the second seedling combing device is less than the rotation speed of the second belt seedling conveyor; and
a tray extending upward at an incline is installed on the air outlet of the blower; seedlings leaving the second belt seedling conveyor fall into the tray; and under an action of air flow from the air outlet of the blower, the seedlings are thrown upward.

2. The intelligent self-sequencing rice seedling throwing machine according to claim 1, wherein the first belt seedling conveyor is installed at an incline, the second belt seedling conveyor is installed horizontally; a front end of the first belt seedling conveyor is lower than a rear end thereof; an inclination angle R1 of the first belt seedling conveyor is 15-45 degrees; and a distance H1 from the end of the first belt seedling conveyor to the second belt seedling conveyor is 50 mm-150 mm.

3. The intelligent self-sequencing rice seedling throwing machine according to claim 2, wherein the rotation speed of the first belt seedling conveyor is 5-25 r/min; the rotation speed of the second belt seedling conveyor is 5-25 r/min; the rotation speed of the first seedling combing device is 5-25 r/min; the rotation speed of the second seedling combing device is 2-12 r/min; an air speed at the air outlet of the blower is 20-45 m/s; and an inclination angle R2 of the air outlet of the blower is 20-45 degrees.

4. The intelligent self-sequencing rice seedling throwing machine according to claim 1, wherein the first seedling combing device comprises a first comb shaft and at least two raking rods; wherein the at least two raking rods are uniformly installed in a circumferential direction of the first comb shaft, and each raking rod extends transversely along an axial direction of the first comb shaft.

5. The intelligent self-sequencing rice seedling throwing machine according to claim 1, wherein the second seedling combing device comprises a second comb shaft and protrusions; and the protrusions are uniformly installed on a circumferential surface of the second comb shaft.

6. The intelligent self-sequencing rice seedling throwing machine according to claim 1, further comprising:
a first motor, a second motor, and a third motor; wherein the first motor drives the first belt seedling conveyor and the first seedling combing device to rotate; the second motor drives the second belt seedling conveyor and the second seedling combing device to rotate; and the third motor drives the seedling picker to rotate.

7. The intelligent self-sequencing rice seedling throwing machine according to claim 6, further comprising:
a controller, a first sensor, a second sensor, a third sensor, a fourth sensor, and a fifth sensor; wherein the first sensor detects a rotation speed of the first motor; the second sensor detects a rotation speed of the second motor; the third sensor detects a rotation speed of the seedling picker; the fourth sensor detects an air speed at the air outlet of the blower; the fifth sensor detects a traveling speed of the chassis; the controller acquires signals from the first sensor, the second sensor, the third sensor, the fourth sensor, and the fifth sensor, controls throwing height and distance based on the rotation speed of the second motor and the air speed at the air outlet of the blower, controls throwing row spacing based on the traveling speed of the chassis, and controls throwing density based on the rotation speed of the first motor, the rotation speed of the second motor, and the rotation speed of the third motor.

8. The intelligent self-sequencing rice seedling throwing machine according to claim 2, further comprising:
a first motor, a second motor, and a third motor; wherein the first motor drives the first belt seedling conveyor and the first seedling combing device to rotate; the second motor drives the second belt seedling conveyor and the second seedling combing device to rotate; and the third motor drives the seedling picker to rotate.

9. The intelligent self-sequencing rice seedling throwing machine according to claim 3, further comprising:
a first motor, a second motor, and a third motor; wherein the first motor drives the first belt seedling conveyor and the first seedling combing device to rotate; the second motor drives the second belt seedling conveyor and the second seedling combing device to rotate; and the third motor drives the seedling picker to rotate.

10. The intelligent self-sequencing rice seedling throwing machine according to claim 4, further comprising:
a first motor, a second motor, and a third motor; wherein the first motor drives the first belt seedling conveyor and the first seedling combing device to rotate; the second motor drives the second belt seedling conveyor and the second seedling combing device to rotate; and the third motor drives the seedling picker to rotate.

11. The intelligent self-sequencing rice seedling throwing machine according to claim 5, further comprising:
a first motor, a second motor, and a third motor; wherein the first motor drives the first belt seedling conveyor and the first seedling combing device to rotate; the second motor drives the second belt seedling conveyor and the second seedling combing device to rotate; and the third motor drives the seedling picker to rotate.

12. The intelligent self-sequencing rice seedling throwing machine according to claim 8, further comprising:
a controller, a first sensor, a second sensor, a third sensor, a fourth sensor, and a fifth sensor; wherein the first sensor detects a rotation speed of the first motor; the second sensor detects a rotation speed of the second motor; the third sensor detects a rotation speed of the seedling picker; the fourth sensor detects an air speed at the air outlet of the blower; the fifth sensor detects a traveling speed of the chassis; the controller acquires signals from the first sensor, the second sensor, the third sensor, the fourth sensor, and the fifth sensor, controls throwing height and distance based on the rotation speed of the second motor and the air speed at the air outlet of the blower, controls throwing row spacing based on the traveling speed of the chassis, and controls throwing density based on the rotation speed of the first motor, the rotation speed of the second motor, and the rotation speed of the third motor.

13. The intelligent self-sequencing rice seedling throwing machine according to claim 9, further comprising:
a controller, a first sensor, a second sensor, a third sensor, a fourth sensor, and a fifth sensor; wherein the first sensor detects a rotation speed of the first motor; the second sensor detects a rotation speed of the second motor; the third sensor detects a rotation speed of the seedling picker; the fourth sensor detects an air speed at the air outlet of the blower; the fifth sensor detects a traveling speed of the chassis; the controller acquires signals from the first sensor, the second sensor, the third sensor, the fourth sensor, and the fifth sensor, controls throwing height and distance based on the rotation speed of the second motor and the air speed at the air outlet of the blower, controls throwing row spacing based on the traveling speed of the chassis, and controls throwing density based on the rotation speed of the first motor, the rotation speed of the second motor, and the rotation speed of the third motor.

14. The intelligent self-sequencing rice seedling throwing machine according to claim 10, further comprising:
a controller, a first sensor, a second sensor, a third sensor, a fourth sensor, and a fifth sensor; wherein the first sensor detects a rotation speed of the first motor; the second sensor detects a rotation speed of the second motor; the third sensor detects a rotation speed of the seedling picker; the fourth sensor detects an air speed at the air outlet of the blower; the fifth sensor detects a traveling speed of the chassis; the controller acquires signals from the first sensor, the second sensor, the third sensor, the fourth sensor, and the fifth sensor, controls throwing height and distance based on the rotation speed of the second motor and the air speed at the air outlet of the blower, controls throwing row spacing based on the traveling speed of the chassis, and controls throwing density based on the rotation speed of the first motor, the rotation speed of the second motor, and the rotation speed of the third motor.

15. The intelligent self-sequencing rice seedling throwing machine according to claim 11, further comprising:
a controller, a first sensor, a second sensor, a third sensor, a fourth sensor, and a fifth sensor; wherein the first sensor detects a rotation speed of the first motor; the second sensor detects a rotation speed of the second motor; the third sensor detects a rotation speed of the seedling picker; the fourth sensor detects an air speed at the air outlet of the blower; the fifth sensor detects a traveling speed of the chassis; the controller acquires signals from the first sensor, the second sensor, the third sensor, the fourth sensor, and the fifth sensor, controls throwing height and distance based on the rotation speed of the second motor and the air speed at the air outlet of the blower, controls throwing row spacing based on the traveling speed of the chassis, and controls throwing density based on the rotation speed of the first motor, the rotation speed of the second motor, and the rotation speed of the third motor.
